(19) United States
(12) Patent Application Publication
(10) Pub. No.: US 2013/0311184 A1
(43) Pub. Date: Nov. 21, 2013

(54) METHOD AND SYSTEM FOR SPEECH RECOGNITION

(71) Applicants: Nilay Chokhoba Badavne, Taipei City (TW); Tai-Ming Parng, Taipei City (TW); Po-Yuan Yeh, Taipei City (TW); Vinay Kumar Baapanapalli Yadaiah, Taipei City (TW)

(72) Inventors: Nilay Chokhoba Badavne, Taipei City (TW); Tai-Ming Parng, Taipei City (TW); Po-Yuan Yeh, Taipei City (TW); Vinay Kumar Baapanapalli Yadaiah, Taipei City (TW)

(21) Appl. No.: 13/705,168

(22) Filed: Dec. 5, 2012

(30) Foreign Application Priority Data
May 18, 2012 (TW) 101117791

(51) Int. Cl. G10L 15/14

(52) U.S. Cl. CPC G10L 15/14
USPC 704/250

(57) ABSTRACT

A method and a system for speech recognition are provided. In the method, vocal characteristics are captured from speech data and used to identify a speaker identification of the speech data. Next, a first acoustic model is used to recognize a speech in the speech data. According to the recognized speech and the speech data, a confidence score of the speech recognition is calculated and it is determined whether the confidence score is over a threshold. If the confidence score is over the threshold, the recognized speech and the speech data are collected, and the collected speech data is used for performing a speaker adaptation on a second acoustic model corresponding to the speaker identification.

### CROSS-REFERENCE TO RELATED APPLICATION

This application claims the priority benefit of Taiwan application serial no. 101117791, filed on May 18, 2012. The entirety of the above-mentioned patent application is hereby incorporated by reference herein and made a part of this specification.

### BACKGROUND OF THE INVENTION

1. Field of the Invention

The disclosure is related to a method and a system for speech recognition, and more particularly to a method and a system for speech recognition adapted for different speakers.

2. Description of Related Art

Automatic speech recognition systems utilize speaker independent acoustic models to recognize every single word spoken by a speaker. Such speaker independent acoustic modes are created by using speech data of multiple speakers and known transcriptions from a large number of speech corpuses. Such methods produce average speaker independent acoustic models may not provide accurate recognition results to different speakers with unique way to speak. In addition, the recognition accuracy of the system would drastically drop if the users of the system are non-native speakers or children.

Speaker dependent acoustic models provide high accuracy as vocal characteristics of each speaker will be modeled into the models. Nevertheless, to produce such speaker dependent acoustic models, a large amount of speech data is needed so that a speaker adaptation can be performed.

A method usually used for training the acoustic model is an off-line supervised speaker adaptation. In such method, the user is asked to read out a pre-defined speech repeatedly, and the speech of the user is recorded as speech data. After the speech data with enough amount of speech is collected, the system performs a speaker adaptation according to the known speech and the collected speech data so as to establish an acoustic model for the speaker. However, in many systems, applications or devices, users are unwilling to go through such training session, and it becomes quite difficult and unpractical to collect enough speech data from a single speaker for establishing the speaker dependent acoustic model.

Another method is an on-line unsupervised speaker adaptation, in which the speech data of the speaker is first recognized, and then an adaptation is performed on the speaker independent acoustic model according to a recognized transcript during the runtime of the system. In this method, although an on-line speaker adaptation can be provided, the speech data is required to be recognized before the adaptation. Comparing with the method of the off-line adaptation of the speech, the recognition result of the on-line speaker adaptation would not be completely accurate.

### SUMMARY OF THE INVENTION

Accordingly, the disclosure is related to a method and a system for speech recognition, in which a speaker identification of speech data is recognized so as to perform a speaker adaptation on an acoustic model.

The disclosure provides a method for speech recognition. In the method, at least one vocal characteristic is captured from speech data so as to identify a speaker identification of the speech data. Next, a first acoustic model is used to recognize a speech in the speech data. According to the recognized speech and the speech data, a confidence score of the recognized speech is calculated, and whether the confidence score is over a first threshold is determined. If the confidence score is over the first threshold, the recognized speech and the speech data are collected, and the collected speech data is used for performing a speaker adaptation on a second acoustic model corresponding to the speaker identification.

The disclosure provides a system for speech recognition, which includes a speaker identification module, a speech recognition module, an utterance verification module, a data collection module and a speaker adaptation module. The speaker identification module is configured to capture at least one vocal characteristic from speech data so as to identify a speaker identification of the speech data. The speech recognition module is configured to recognize a speech in the speech data by using a first acoustic model.

The utterance verification module is configured to calculate a confidence score according to the speech and the speech data recognized by the speech recognition module and to determine whether the confidence score is over a first threshold. The data collection module is configured to collect the speech and the speech data recognized by the speech recognition module if the utterance verification module determines that the confidence score is over the first threshold. The speaker adaptation module is configured to perform a speaker adaptation on a second acoustic model corresponding to the speaker identification by using the speech data collected by the data collection module.

Based on the above, in the method and the system for speech recognition of the disclosure, dedicated acoustic models for different speakers are established, and the confidence scores for recognizing the speech data are calculated when the speech data is received. Accordingly, whether to use the speech data to perform the speaker adaptation on the acoustic model corresponding to the speaker can be decided, and the accuracy of speech recognition can be enhanced.

Several embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating a speech recognition system according to an embodiment of the present disclosure.

FIG. 2 is a flowchart illustrating a speech recognition method according to an embodiment of the disclosure.

FIG. 3 is a flowchart illustrating a method of selecting an acoustic model based on a speaker identification to recognize a speech data according to an embodiment of the disclosure.

FIG. 4 is a flowchart illustrating a method of establishing an acoustic model according to an embodiment of the disclosure.

FIG. 5 is a block diagram illustrating a speech recognition system according to another embodiment of the disclosure.

FIG. 6 is a flowchart illustrating a speech recognition method according to another embodiment of the disclosure.

### DESCRIPTION OF EMBODIMENTS

In the disclosure, speech data input by different speakers is collected, a speech in the speech data is recognized, and the accuracy of the recognized speech is verified, so as to decide whether to use the speech to perform a speaker adaptation and generate an acoustic model for a speaker. With the increment of the collected speech data, the acoustic model is adapted to being incrementally close to vocal characteristics of the speaker, while the acoustic models dedicated to different speakers are automatically switched and used, such that the recognition accuracy can be increased.

As described above, the collection of the speech data and the adaptation of the acoustic model are performed in the background and thus, can be automatically performed under the situation that the user is not aware of or not disturbed, such that the usage convenience is achieved.

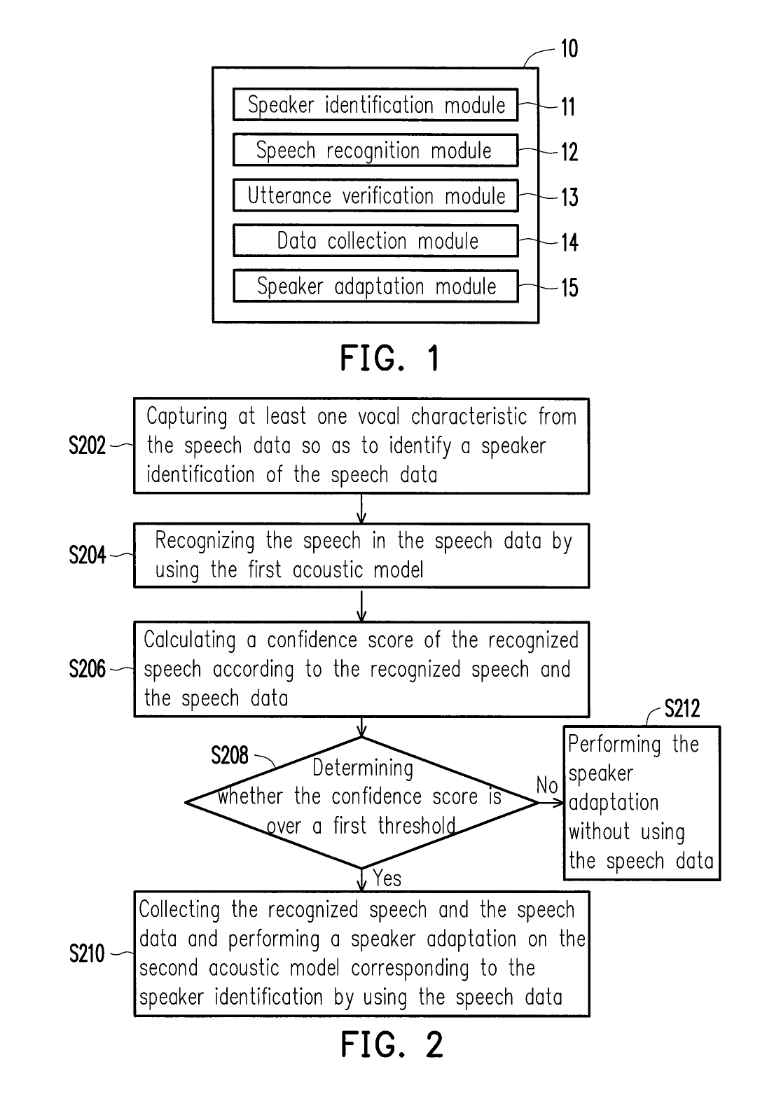

FIG. 1 is a block diagram illustrating a speech recognition system according to an embodiment of the disclosure. FIG. 2 is a flowchart illustrating a speech recognition method according to an embodiment of the disclosure. Referring to FIG. 1 with FIG. 2, a speech recognition system 10 of the present embodiment includes a speaker identification module 11, a speech recognition module 12, an utterance verification module 13, a data collection module 14 and a speaker adaptation module 15. Hereinafter, steps of the method for speech recognition of the present embodiment will be described in detail with reference to each component of the speech recognition system 10.

First, the speaker recognition module 11 receives speech data input by a speaker, captures at least one vocal characteristic from the speech data and uses the same to identify a speaker identification of the speech data (step S202). The speaker identification module 11, for example, uses acoustic models of a plurality of speakers in an acoustic model database (not shown), which has been previously established in the speech recognition system 10, to recognize the vocal characteristic in the speech data. According to a recognition transcript of the speech data obtained by using the acoustic model, the speaker identification of the speech data can be determined by the speaker identification module 11.

Next, the speech recognition module 12 recognizes a speech in the speech data by using a first acoustic model (step S204). The speech recognition module 12, for example, applies an automatic speech recognition (ASR) technique and uses a speaker independent acoustic model to recognize the speech in the speech data. Such speaker independent acoustic model is, for example, built in the speech recognition system 10 and configured to recognize the speech data input by an unspecified speaker.

It should be mentioned that the speech recognition system 10 of the present embodiment may further establish the acoustic model dedicated to each different speaker and give a specified speaker identification to the speaker or to the acoustic model thereof Thus, every time when the speech data input by the speaker having the built acoustic model is received, the speaker identification module 11 can immediately identify the speaker identification, and accordingly select the acoustic model corresponding to the speaker identification to recognize the speech data.

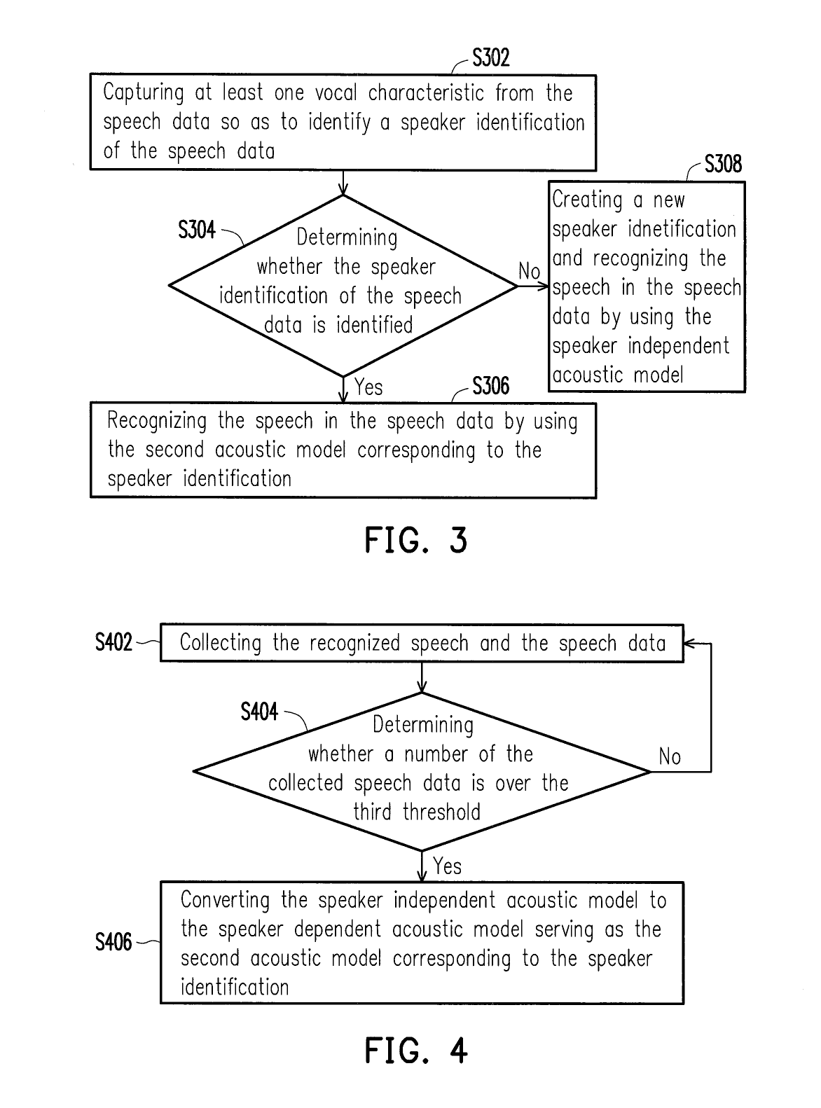

For example, FIG. 3 is a flowchart illustrating a method of selecting an acoustic model based on a speaker identification to recognize a speech data according to an embodiment of the disclosure. Referring to FIG. 3, the speaker identification module 11 captures at least one feature from the speech data so as to identify the speaker identification of the speech data (step S302). Then, the speech recognition module 12 further determines whether the speaker identification of the speech data is identified by the speaker identification module 11 (step S304).

Herein, if the speaker identification can be identified by the speaker identification module 11, the speech recognition module 12 receives the speaker identification from the speaker identification module 11 and uses an acoustic model corresponding to the speaker identification to recognize a speech in the speech data (step S306). Otherwise, if the speaker identification can not be identified by the speaker identification module 11, a new speaker identification is created, and when the new speaker identification is received from the speaker identification module 11, the speech recognition module 12 uses a speaker independent acoustic model to recognize the speech in the speech data (step S308).

Thus, even though there is no acoustic model corresponding to the speech data of the speaker, the speech recognition system 100 still can recognize the speech data by using the speaker independent acoustic model so as to establish the acoustic model dedicated to the speaker.

Returning back to the process illustrated in FIG. 2, after the speech in the speech data is recognized by the speech recognition module 12, the utterance verification module 13 calculates a confidence score of the recognized speech according to the speech and the speech data recognized by the speech recognition module 12 (step S206). Herein, the utterance verification module 13, for example, uses an utterance verification technique to estimate the confidence score so as to determine the correctness of the recognized speech.

Afterward, the utterance verification module 13 determines whether the calculated confidence score is over a first threshold (step S208). When the confidence score is over the first threshold, the speech and the speech data recognized by the speech recognition module 12 are output and collected by the data collection module 14. The speaker adaptation module 15 uses the speech data collected by the data collection module 14 to perform a speech adaptation on a second acoustic model corresponding to the speaker identification (step S210).

Otherwise, when the utterance verification module 13 determines the confidence score is not over the first threshold, the data collection module 14 does not collect the speech data, and the speaker adaptation module 15 does not use the speech data to perform the speaker adaptation (step S212).

In detail, the data collection module 14, for example, stores the speech data having a high confidence score and the speech thereof in a speech database (not shown) of the speech recognition system 10 for the use of the speaker adaptation on the acoustic model. The speaker adaptation module 15 determines whether an acoustic model corresponding to the speaker is already established in the utterance verification module 13 according to the speaker identification identified by the speaker identification module 11.

If there is a corresponding acoustic model in the system, the speaker adaptation module 15 uses the speech and the speech data collected by the data collection module 14 to directly perform the speaker adaptation on the acoustic model so that the acoustic model is adapted to being incrementally close to the vocal characteristics of the speaker. The aforesaid acoustic model is, for example, a statistical model by adopting a Hidden Markov Model (HMM), in which statistics, such as a mean and a variance of historic data, are recorded, and every time when new speech data comes in, the statistics are comparatively changed corresponding to the speech data and finally a more robust statistical model is acquired.

On the other hand, if there is no corresponding acoustic model in the system, the speaker adaptation module 15 further determines whether to perform the speaker adaptation to establish a new acoustic model according to a number of the speech data collected by the data collection module 14.

In detail, FIG. 4 is a flowchart illustrating a method of establishing an acoustic model according to an embodiment of the disclosure. Referring to FIG. 4, in the present embodiment, the data collection module 14 collects the speech and the speech data (step S402). Every time when new speech data is collected by the data collection module 14, the speaker adaptation module 15 determines whether the number of the collected speech data is over a third threshold (step S404).

When it is determined that the number is over the third threshold, it represents that the collected data is efficient to establish an acoustic model. At this time, the speaker adaptation module 15 uses the speech data collected by the data collection module 14 to convert the speaker independent acoustic model to the speaker dependent acoustic model, which is then used as the acoustic model corresponding to the speaker identification (step S406). Otherwise, when it is determined that the number is not over the third threshold, the flow is returned back to step S402, and the data collection module 14 continues to collect the speech and the speech data.

Through aforementioned method, when the user buys a device equipped with the speech recognition system of the disclosure, each of the family members may input the speech data so as to establish the acoustic model thereof. With the increment of times that each family member uses the device, each acoustic model is adapted to being incrementally close to the vocal characteristics of each family member. In addition, every time when the speech data is received, the speech recognition system automatically identifies the identification of each family member and selects the corresponding acoustic model to perform the speech recognition so that the correctness of the speech recognition can be increased.

Besides the scoring mechanism for the correctness of the speech recognition as described above, in the disclosure, a scoring mechanism for pronunciation is developed for multiple utterances in the speech data and configured to filter the speech data, by which the speech data with a correct semantic but incorrect pronunciation is removed. Hereinafter, an embodiment is further illustrated in detail.

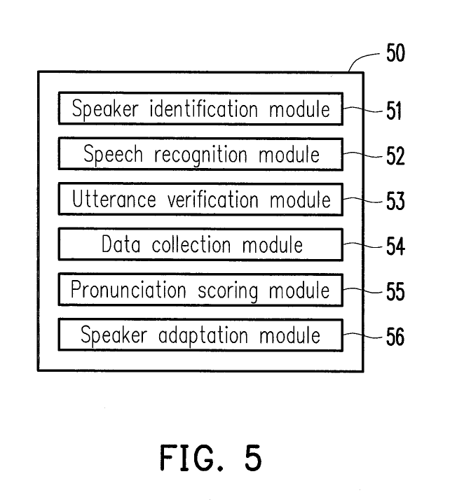

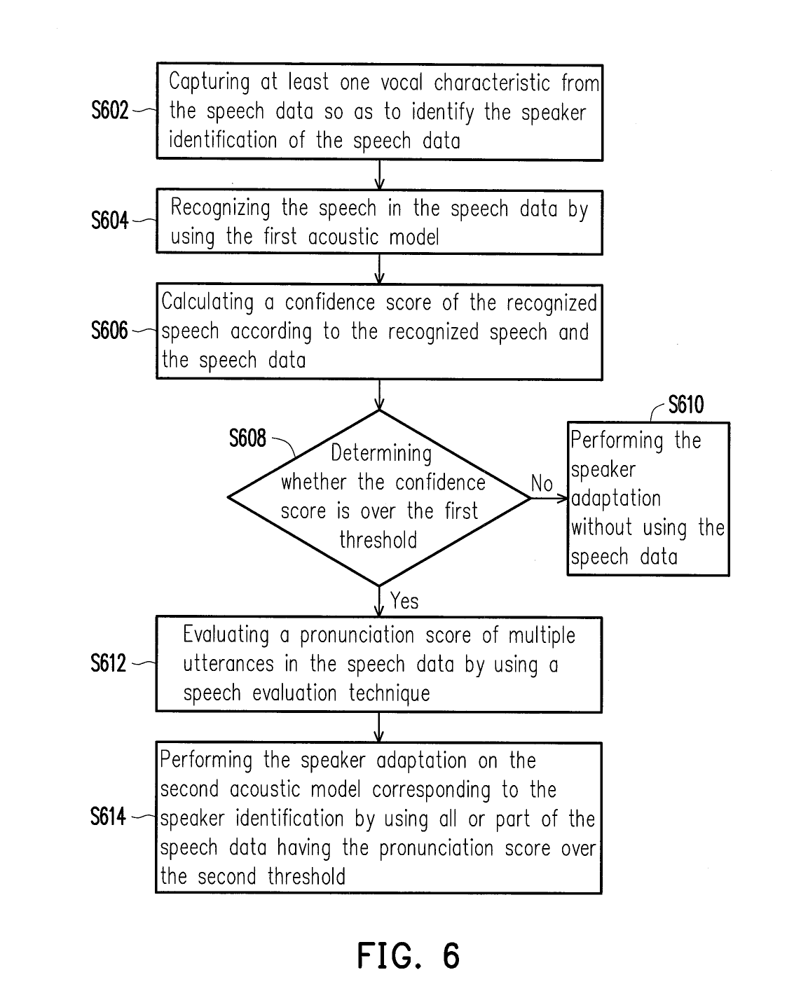

FIG. 5 is a block diagram illustrating a speech recognition system according to another embodiment of the disclosure. FIG. 6 is a flowchart illustrating a speech recognition method according to another embodiment of the disclosure. Referring to FIG. 5 and FIG. 6, a speech recognition system 50 includes a speaker identification module 51, a speech recognition module 52, an utterance verification module 53, a data collection module 54, a pronunciation scoring module 55 and a speaker adaptation module 56. Steps of a method for speech recognition of the present embodiment with reference to each component of speech recognition system 50 illustrated in FIG. 5 will be described in detail as follows.

First, the speaker identification module 51 receives speech data input by a speaker and captures at least a vocal characteristic from the speech data so as to identify a speaker identification of the speech data (step S602). Then, the speech recognition module 52 uses a first acoustic model to recognize a speech in the speech data (step S604). Afterward, the utterance verification module 53 calculates a confidence score the speech and the speech data recognized by the speech recognition module 52 (step S606) and determines whether the confidence score is over a first threshold (step S608). When the confidence score is not over the first threshold, the utterance verification module 53 does not output the recognized speech and the speech data, and the speech data is not used for performing a speaker adaptation (step S610).

Otherwise, when it is determined that the confidence score is over the first threshold, the utterance verification module 53 outputs the recognized speech and the speech data, and the pronunciation scoring module 55 further uses a speech evaluation technique to evaluate a pronunciation score of multiple utterances in the speech data (step S612). The pronunciation scoring module 55, for example, evaluates the utterances such as a phoneme, a word, a phrase and a sentence in the speech data so as to provide detailed information related to each utterance.

Next, the speaker adaptation module 56 determines whether the pronunciation score evaluated by the pronunciation scoring module 55 is over a second threshold, so as to use all or part of the speech data having the pronunciation score over the second threshold to perform the speaker adaptation on the second acoustic model corresponding to the speaker identification (step S614).

By the method described above, the speech data with incorrect pronunciation is further filtered out so that the deviation of the acoustic model resulted from using such speech data to perform the adaptation on the acoustic model can be averted.

To sum up, in the method and the system for speech recognition of the disclosure, the speaker identification of the speech data is identified so as to select the acoustic model corresponding to the speaker identification for speech recognition. Accordingly, the accuracy of the speech recognition can be significantly increased. Further, a confidence score and a pronunciation score of the speech recognition result are calculated so as to filter out the speech data having incorrect semantic and incorrect pronunciation. Only the speech data with the higher scores and reference value is used to perform the speaker adaptation on the acoustic model. Accordingly, the acoustic model can be adapted to being close to the vocal characteristics of the speaker and the recognition accuracy can be increased.

Although the disclosure have been described with reference to the above embodiments, it will be apparent to one of the ordinary skill in the art that modifications to the described embodiment may be made without departing from the spirit of the described embodiment. Accordingly, the scope of the disclosure will be defined by the attached claims not by the above detailed descriptions.

What is claimed is:

1. A method for speech recognition, comprising:
capturing at least one vocal characteristic from a speech data so as to identify a speaker identification of the speech data;
recognizing a speech in the speech data by using a first acoustic model;
calculating a confidence score of the speech according to the recognized speech and the speech data and determining whether the confidence score is over a first threshold; and
if the confidence score is over the first threshold, collecting the recognized speech and the speech data and performing a speaker adaptation on a second acoustic model corresponding to the speaker identification by using the speech data.

2. The method for speech recognition as recited in claim 1, wherein the step of capturing the at least one vocal characteristic from a speech data so as to identify the speaker identification of the speech data comprises:
recognizing the at least one vocal characteristic by using the second acoustic model that is previously established for each of a plurality of speakers, so as to identify the speaker identification of the speech data according to a recognition transcript of each second acoustic model.

3. The method for speech recognition as recited in claim 1, wherein the step of recognizing the speech in the speech data by using the first acoustic model comprises:
determining whether the speaker identification of the speech data is identified;
if the speaker identification is not identified, creating a new speaker identification and recognizing the speech in the speech data by using a speaker independent acoustic model; and
if the speaker identification is identified, recognizing the speech in the speech data by using the second acoustic model corresponding to the speaker identification.

4. The method for speech recognition as recited in claim 1, wherein the step of calculating the confidence score of the speech according to the recognized speech and the speech data comprises:
estimating the confidence score of the recognized speech by using an utterance verification technique.

5. The method for speech recognition as recited in claim 1, wherein the steps of collecting the recognized speech and the speech data and performing the speaker adaptation on the second acoustic model corresponding to the speaker identification by using the speech data to comprises:
evaluating a pronunciation score of a plurality of utterances in the speech data by using a speech evaluation technique and determining whether the pronunciation score is over a second threshold; and
performing the speaker adaptation on the second acoustic model corresponding to the speaker identification by using all or part of the speech data having the pronunciation score greater than the second threshold.

6. The method for speech recognition as recited in claim 5, wherein the plurality of utterances comprises one of a phoneme, a word, a phrase and a sentence or a combination thereof.

7. The method for speech recognition as recited in claim 1, wherein the step of recognizing the speech in the speech data by using the first acoustic model comprises:
recognizing the speech in the speech data by using an automatic speech recognition (ASR) technique.

8. The method for speech recognition as recited in claim 1, wherein the steps of collecting the recognized speech and the speech data and performing the speaker adaptation on the second acoustic model corresponding to the speaker identification by using the speech data comprises:
determining whether a number of the collected speech data is over a third threshold; and
when the number is over the third threshold, converting a speaker independent acoustic model to a speaker dependent acoustic model serving as the second acoustic model corresponding to the speaker identification by using the collected speech data.

9. The method for speech recognition as recited in claim 1, wherein the first acoustic model and the second acoustic model are Hidden Markov Models (HMMs).

10. A system for speech recognition, comprising:
a speaker identification module, capturing at least one vocal characteristic from a speech data so as to identify a speaker identification of the speech data;
a speech recognition module, recognizing a speech in the speech data by using a first acoustic model;
an utterance verification module, calculating a confidence score of the speech according to the speech recognized by the speech recognition module and the speech data and determining whether the confidence score is over a first threshold;
a data collection module, collecting the speech recognized by the speech recognition module and the speech data when the utterance verification module determines that the confidence score is over the first threshold; and
a speaker adaptation module, performing a speaker adaptation on a second acoustic model corresponding to the speaker identification by using the speech data collected by the data collection module.

11. The system for speech recognition as recited in claim 10, further comprising:
an acoustic model database, recording a plurality of pre-established second acoustic models of a plurality of speakers.

12. The system for speech recognition as recited in claim 11, wherein the speaker identification module recognizes the at least one vocal characteristic by using the plurality of second acoustic models of the plurality of speakers in the acoustic model database, so as to identify the speaker identification of the speech data according to a recognition result of each second acoustic model.

13. The system for speech recognition as recited in claim 12, wherein the speaker identification module further determines whether the speaker identification of the speech data is identified, wherein
if the speaker identification is not identified, a new speaker identification is created, and the speech recognition module recognizes the speech in the speech data by using a speaker independent acoustic model, and
if the speaker identification is identified, the speech recognition module recognizes the speech in the speech data by using the second acoustic model corresponding to the speaker identification.

14. The system for speech recognition as recited in claim 10, wherein the utterance verification module evaluates the confidence score of the recognized speech by using an utterance verification technique.

15. The system for speech recognition as recited in claim 10, further comprising:
a pronunciation scoring module, evaluating a pronunciation score of a plurality of utterances in the speech data by using a speech evaluation technique.

16. The system for speech recognition as recited in claim 15, wherein the speaker adaptation module further determines whether the pronunciation score evaluated by the pronunciation scoring module is over a second threshold, and performs the speaker adaptation on the second acoustic model corresponding to the speaker identification by using all or part of the speech data having the pronunciation score over the second threshold.

17. The system for speech recognition as recited in claim 16, wherein the plurality of utterances comprises one of a phoneme, a word, a phrase and a sentence or a combination thereof.

18. The system for speech recognition as recited in claim 10, wherein the speech recognition module recognizes the speech in the speech data by using an automatic speech recognition (ASR) technique.

19. The system for speech recognition as recited in claim 10, wherein the speaker adaptation module further determines whether a number of the speech data collected by the data collection module is over a third threshold, and converts the speaker independent acoustic model to a speaker dependent acoustic model serving as the second acoustic model corresponding to the speaker identification by using the speech data collected by the data collection module when the number is over the third threshold.

20. The system for speech recognition as recited in claim 10, wherein the first acoustic model and the second acoustic model Hidden Markov Models (HMMs).
